(19) United States
(12) Patent Application Publication
(10) Pub. No.: US 2005/0097200 A1
(43) Pub. Date: May 5, 2005

(54) System and method for aggregating sensor devices using a network

(76) Inventors: Donald R. Denning JR., Shirley, MA (US); Brian Avery, Lexington, MA (US); Steven M. Ayer, Marblehead, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/684,667

(22) Filed: Oct. 14, 2003

(51) Int. Cl. G06F 15/173

(52) U.S. Cl. 709/223; 709/224

(57) ABSTRACT

Several sensors or other data collecting and transmitting devices may be made accessible to computers on a network by advertising their presence and establishing communications. This may be accomplished by using a standard network protocol and an aggregating device on the network. One such protocol is the Session Initiation Protocol. The sensor devices may be heterogeneous.

### BACKGROUND OF THE INVENTION

Modern electronic technologies allow a broad variety of devices to be connected to, controlled over, and communicated with via global and local computer networks, such as the Internet and local area networks. The electronic components necessary to enable such network connections, control, and communications may be embedded, for example, into various sensors and other devices taking physical measurements. This permits the transmission of data representing the physical values measured by the sensors over the network to a remote user and the control of sensors' functioning by the remote user over the network. Such connections may be wireless, which broadens the spectrum of available applications.

A popular type of networks is the so-called Internet Protocol (IP) based networks, i.e., the networks conforming to Request for Comments (RFC) 0791 and RFC 1349 distributed by the Internet Engineering Task Force (IETF). IETF maintains, develops, and distributes a variety of network standards commonly referred to by their numbers as RFCs. A global IP network comprising a large number of interconnected local networks is known as the Internet. A full set of RFC's is available at the IETF's Internet site.

An IP network is a packet-switched network. A packet consists of binary data. It is sent from one network device to another network device usually through several intermediate network devices known as routers, which determine to which network device the packet must be directed in order to eventually arrive at the destination device. A network device may be a computer or any other device as long as it is capable of performing the required network tasks.

### SUMMARY OF THE INVENTION

Embodiments of this invention include systems or methods for network communication of sensor devices on a network comprising the steps of connecting a sensor device to a network; connecting an aggregating device to the network; and transmitting sensor information from the sensor device to the aggregating device. The sensor information may be transmitted using the Session Initiation Protocol (SIP), where the sensor device may be an SIP user agent, and the aggregating device may be an SIP server. The aggregating device may also be an SIP registrar. The sensor device may be a physiology sensor device.

These systems or methods may further comprise connecting a second sensor device to the network and transmitting sensor information from the second sensor device to the aggregating device.

The sensor devices may be heterogeneous. The sensor information may include communication sensor information and sensor data.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of one embodiment of this invention.

FIG. 2 is a schematic diagram of another embodiment of this invention.

FIG. 3 is a schematic diagram of a third embodiment of this invention.

FIG. 4 is a schematic diagram of a fourth embodiment of this invention.

FIG. 5 is a flow chart showing operation of an embodiment of this invention.

### DETAILED DESCRIPTION OF THE INVENTION

A description of preferred embodiments of the invention follows.

The present invention depends for its operation on the presence of a computer network, as defined above. This network may be an IP network but it does not have to be. Any network of devices capable of providing the required functionality would suffice to enable an embodiment of this invention. The word network is used in this sense throughout this application.

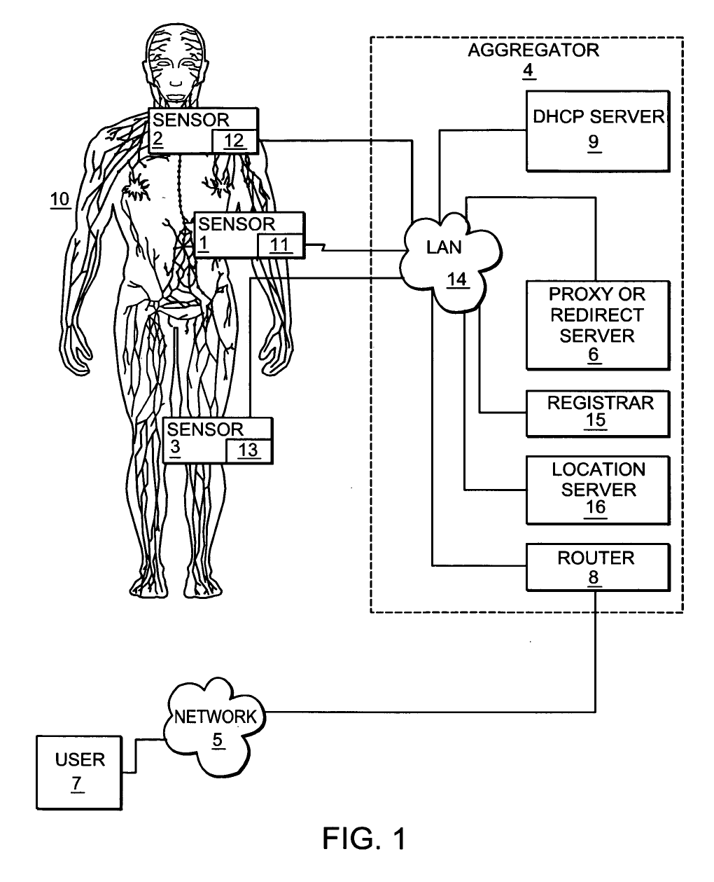

FIG. 1 shows an embodiment of this invention. Sensors 1, 2, and 3 take a variety of physiological or other measurements, for example, blood pressure, heart rate, blood oxygen content, and others of a patient or target 10. Each of these sensors includes a respective network interface, 11, 12, and 13, capable of transmitting the sensed data over a local area network 14 and a network 5 to a user 7 of the data (such as a doctor or hospital, distinguished from the patient 10). The transmission may occur directly to the user 7, via a common router 8, as shown in FIG. 1, or through multiple routers. In an IP network, such as the Internet, such routers may be IP routers. The user 7 may be a network device collecting data and/or alerting medical personnel in cases when their attention is needed. The protocol used to transmit the sensed data may be one of many protocols developed for data delivery over the network 5. For example, if the network 5 is an IP network, the data may be transmitted using a variety of application layer protocols used to transmit the data as well as to regulate various parameters and features of the data transmission, such as Hypertext Transfer Protocol (HTTP, RFC 2616), Real-time Transfer Protocol (RTP, RFC 3550), and others. The exact nature of the data and the methods of transmission are outside the scope of this invention.

The sensors 1, 2, and 3 are not limited to human physiology sensors or to medical patients. They may be, for example, environmental sensors or sensors attached to an animal or installed on a mechanical device. Another area of application where this invention may be relevant is monitoring soldiers' conditions and other parameters on the battlefield. These sensors do not have to be configurable or have any user interface. This invention allows integration of interfaceless sensors into sophisticated network environments simply by plugging them into a network wire socket and, on a wireless network, even this simple step is not required. For example, in a medical environment, a medical sensor may begin participating in centralized data gathering as soon as it is attached to a patient and turned on.

Before a sensor 1, 2, or 3 may begin the transmission of data, it must determine when, where, and how to transmit, i.e. which network protocol and network destination to use. On an IP network, for example, the network destination may be an IP address, which may be expressed as a number or as a domain name, e.g. “hospital.com”. To determine the network destination and to set other parameters of communications between the sensors 1, 2, and 3 and the user 7, some embodiments of this invention use the Session Initiation Protocol (SIP, RFC 3261) a protocol for creating, modifying, and terminating sessions with one or more participants. SIP allows Internet devices (called user agents, or UAs) to discover one another and to agree on a characterization of a communication session they would like to begin. For locating prospective communication participants, and for other functions, SIP uses network devices (called servers) to which UAs can send registrations, invitations to communications, and other requests. The SIP server types include registration servers, redirect servers, proxy servers, and others, their functions are described below. SIP works independently of underlying protocols and without dependency on the type of communication that is being established.

The sensors 1, 2, and 3 may be treated as SIP UAs as long as their respective network interfaces 11, 12, and 13 have the necessary SIP capabilities; such is the case with the embodiment shown in FIG. 1.

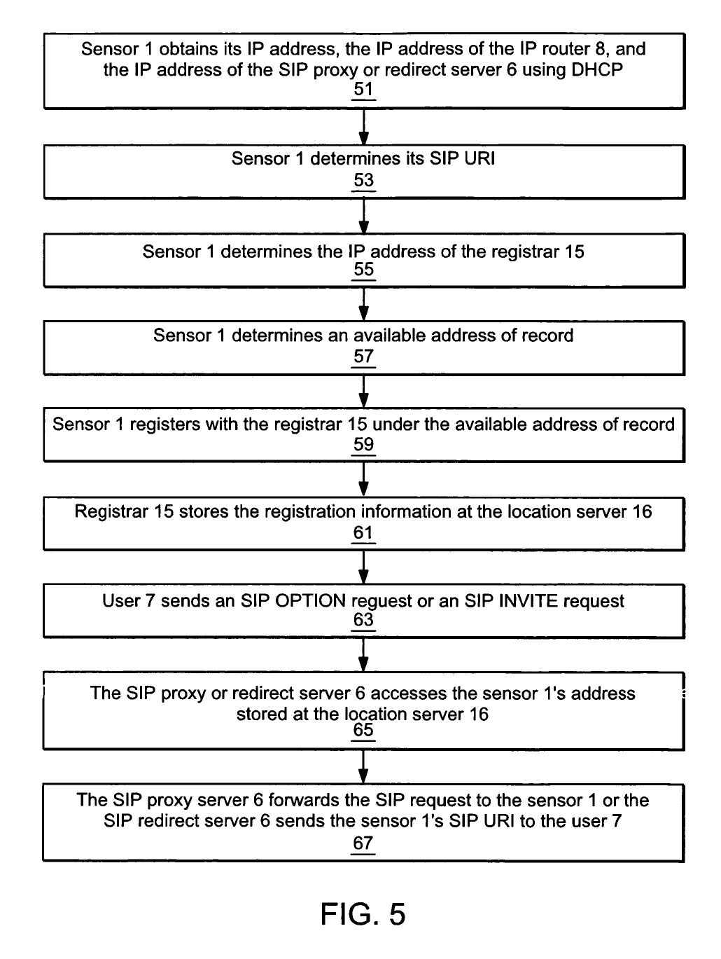

In the embodiment shown in FIG. 1, after the sensor 1 (or 2, or 3) is turned on and is physically connected to the local network 14, it determines several parameters, step 51 in FIG. 5. These parameters may include its IP address, the IP address of an IP router 8 on the local network 14, the IP address of an SIP proxy or redirect server 6, and others. This address assignment and providing the sensor 1 with its assigned IP address may be accomplished using the Dynamic Host Configuration Protocol (DHCP, RFC 2131) and a DHCP server 9. In the embodiments using the DHCP, this procedure may comprise the following steps: the sensor 1 (acting as a DHCP client) broadcasts a DHCPDISCOVER message on the local network 14; after receiving the DHCPDISCOVER message; the DHCP server 9 broadcasts a DHCPOFFER message containing the IP address for the sensor 1 and other parameters; the sensor 1 broadcasts a DHCPREQUEST message to inform the DHCP server 9 that it has accepted the offered data; and finally the DHCP server 9 sends back a DHCPACK acknowledge message. Some of the parameters returned by this DHCP exchange may require periodic updating in order to stay valid and, therefore, the sensor 1 periodically performs the necessary transactions with the DHCP server 9. The details of these transactions are outside the scope of this invention.

Some of the functions performed by the DHCP server 9 may be performed, in other embodiments, using other protocols, in particular, Reverse Address Resolution Protocol (RARP, RFC 0826), Bootstrap Protocol (BOOTP, RFC 0951), and others. Other embodiments of this invention may use the technique called link-local addressing as described in RFC 2462, “IPv6 Stateless Address Autoconfiguration”. Embodiments of this invention may also permit setting of at least some of the parameters obtainable via the DHCP protocol manually by a system administrator.

Continuing with FIG. 5, in step 51, the IP address of an SIP proxy or redirect server 6 may be determined using the DHCP, as described above, following the specifications provided in RFC 2132, “DHCP Options and BOOTP Vendor Extensions”, and RFC 3361, “Dynamic Host Configuration Protocol (DHCP-for-IPv4) Option for Session Initiation Protocol (SIP) Servers”, or using the Service Location Protocol (SLP, RFC 2608) for this purpose. Hereinafter, the IP address expressed as a domain name patient4.hospital.com will be used as an example of the IP address of the SIP proxy or redirect server 6 obtained by one of the methods described above.

In other embodiments of this invention, the initial parameters, such as the IP address of an SIP proxy or redirect server 6 or sensors' IP address, may be obtained by the sensors by using the Rendezvous networking technology developed by Apple Computer, Inc. or by using a variant of DNS called Multicast DNS-Service Discovery. This invention may also use other self-configuration methods.

In the embodiment of this invention shown in FIG. 1, once the sensor 1 obtains its IP address and other parameters as described above in step 51 in FIG. 5, the next step 53 is to determine its SIP URI (Uniform Resource Indicator). An SIP URI identifies an SIP UA for other SIP UAs. A sensor's SIP URI may be in the form sip:user@host. Here the “user” part may be a unique identifier for the sensor 1, e.g., “MakerTypeSerialNumber”, i.e. “ABCCorpBloodPressure123456”, where “Maker” is the name of the sensor's manufacturer, “Type” is the word or a numeric code defining the sensor type and possibly its other parameters, and “SerialNumber” uniquely identifies the sensor for the given maker and type. The “user” part of the sensor's SIP URI may be a part of the sensor's firmware. In other embodiments, the “user” part of the sensor's SIP URI may be manually set by a system administrator.

Some embodiments of this invention may use global anonymous user IDs to uniquely identify themselves. Such IDs may be obtained during the setup process.

In the embodiment shown in FIG. 1, the IP address of the SIP proxy or redirect server 6 is substituted for the “host” part of the sensor's SIP URI. Thus, the resulting SIP URI for the sensor UA 1 may be sip:ABCCorpBloodPressure123456@patient4.hospital.com. In other embodiments of this invention, the “host” part of the sensor's SIP URI may be manually set by a system administrator.

In the embodiment shown in FIG. 1, the SIP proxy or redirect server 6 is responsible for handling SIP communications between the sensor UAs 1, 2, and 3 and the devices outside the local network 14. In SIP terms, sip:patient4.hospital.com is the domain of sensor UAs 1, 2, and 3. The user 7 is also a UA but may be in a different domain, its SIP URI may be, for example, “sip:doctor3@hospital.com”.

The presence of a sensor in this embodiment of the invention is advertised to other SIP UAs (such as the user 7) by registering an association between its SIP URI and its sensor type using an SIP registrar 15, steps 57 and 59 in FIG. 5. Later, when the SIP proxy or redirect server 6 receives an SIP message addressed to sip:BloodPressure@patient4.hospital.com, for example, from the user 7, the SIP proxy or redirect server 6 consults a location server 16 to determine that this message is intended for sensor 1 and is to be directed to sip:ABCCorpBloodPressure123456@patient4.hospital.com. The advertised address (i.e., sip:BloodPressure@patient4.hospital.com) is referred to as an SIP address of record. To perform this registration, the sensor 1 first determines the IP address of the SIP registrar 15, step 55 in FIG. 5. In this embodiment, the IP address of the SIP registrar 15 is determined by simply appending “registrar.” to the IP address of the SIP proxy or redirect server 6 determined earlier as a domain name. Thus the IP address of the SIP registrar 15 in this embodiment is registrar.patient4.hospital.com. In other embodiments of this invention, the IP address of the SIP registrar 15 may be manually set by a system administrator or the sensor 1 may use a multicast IP address, typically, sip.mcast.net or 224.0.1.75, to communicate with the SIP registrar 15.

SIP does not mandate a particular mechanism for implementing the location server 16 as long as the SIP registrar 15 is able to access and store data and the SIP proxy or redirect server 6 is able to access these data on the location server 16. For this accessing and storing, the location server 16 may, for example, use Lightweight Directory Access Protocol (LDAP, RFC 1777). The details of these communications are outside the scope of this invention.

An SIP REGISTER request comprises several header fields: “Request-URI” header field naming the domain of the location server 16 for which the registration is meant (e.g., sip:patient4.hospital.com), “To” header field containing the SIP address of record whose registration is to be created, queried, or modified (e.g., sip:BloodPressure@patient4.hospital.com), “Contact” header field which may contain the address (e.g., sip:ABCCorpBloodPressure 123456@patient4.hospital.com) to be associated with the address of record, and other header fields.

After the sensor 1 has determined the IP address of the SIP registrar 15, it determines whether a sensor of the same type is already registered with the location server 16 or, in other words, whether the SIP address of record that the sensor 1 is planning to register (e.g., sip:BloodPressure@patient4.hospital.com) is already taken by another sensor, sensor 2 or sensor 3, which may also be blood pressure sensors, step 57 in FIG. 5. This may be determined by sending an SIP REGISTER request with an empty “Contact” header field to the SIP registrar 15. In response, the SIP registrar 15 obtains from the location server 16 the list of addresses associated with the SIP address of record in the “To” header field. If the planned SIP address of record is already taken, it may be modified, for example, by appending a number to it, and again checking whether this new address of record (e.g, sip:BloodPressure1@patient4.hospital.com) is available, as described above.

After an available SIP address of record is determined by the sensor 1, it registers it by sending an SIP REGISTER request to the SIP registrar 15 with the “Contact” header field containing its address (i.e., sip:ABCCorpBloodPressure123456@patient4.hospital.com) to be associated with the address of record (e.g., sip:BloodPressure1@patient4.hospital.com), step 59 in FIG. 5. After receiving this request, the SIP registrar 15 stores this information to the location server 16, step 61 in FIG. 5. This registration usually expires after a certain amount of time and therefore may need to be periodically updated using SIP REGISTER requests.

After the registration of the sensor 1, the user 7 may send an SIP OPTION request to the sensor 1 through the SIP proxy or redirect server 6. SIP OPTION requests allow one SIP UA to determine capabilities of another UA, in particular, the capabilities related to the data transmission over the networks 5 and 14. Also, after the registration of the sensor 1, the user 7 may send an SIP INVITE request to the sensor 1 through the SIP proxy or redirect server 6. The SIP INVITE request contains a session description and is intended to establish a communication session with the user 7. Sending of the SIP OPTION and INVITE requests is shown as step 63 in FIG. 5.

In the embodiment shown in FIG. 1, the user 7 addresses its SIP OPTION and INVITE requests to sip:BloodPressure1@patient4.hospital.com and sends these requests through the IP router 8 to the SIP proxy or redirect server 6. The SIP proxy or redirect server 6, after receiving the request, consults the location server 16 and obtains the address of the sensor 1, in this example, it is sip:ABCCorpBloodPressure123456@patient4.hospital.com, step 65 in FIG. 5. If the embodiment shown in FIG. 1 uses an SIP redirect server 6, the SIP redirect server 6 sends to the user 7 a response containing the address of the sensor 1. If the embodiment uses an SIP proxy server 6, the SIP proxy server 6 forwards the SIP requests to the sensor 1, step 67 in FIG. 5.

The SIP INVITE and optional OPTION requests and responses to these requests transmitted between the sensor 1 and the user 7 allow these two UAs to agree upon a communication protocol for a subsequent network communication session over the networks 14 and 5.

In some embodiments of this invention, the user 7 detects the presence of the sensor 1 by using an extension to SIP protocol described in RFC 2543 (Session Initiation Protocol (SIP)-Specific Event Notification). In such embodiments, the user 7 sends an SIP SUBSCRIBE request to the SIP server 6. When the sensor 1 registers with the SIP registrar 15, SIP server 6 sends an SIP NOTIFY message to the user 7.

When additional sensors 2 and 3 are turned on and connected to the network 14 in the embodiment shown in FIG. 1, they go through the same steps of discovering their parameters such as their SIP URIs, IP addresses, and others, as described above for the sensor 1 and, subsequently, the sensors 2 and 3 are registered by the registration procedure and are discovered via OPTION and/or INVITE requests as described above for the sensor 1. The sensors 1, 2, and 3 may be heterogeneous, i.e., measure different physical values, physiological or not, come from different manufacturers, use different communication protocols, have different set of features and capabilities, etc. as long as they are capable of performing the session

In the embodiment shown in FIG. 1, the DHCP server 9, the SIP proxy or redirect server 6, the SIP registrar 15, the SIP location server 16, and the IP router 8 are separate devices connected to a local network 14. These devices together with the network 14 may be seen or implemented as a single device, an aggregator 4. Other embodiments of this invention may implement these functional components in hardware or software or other combinations.

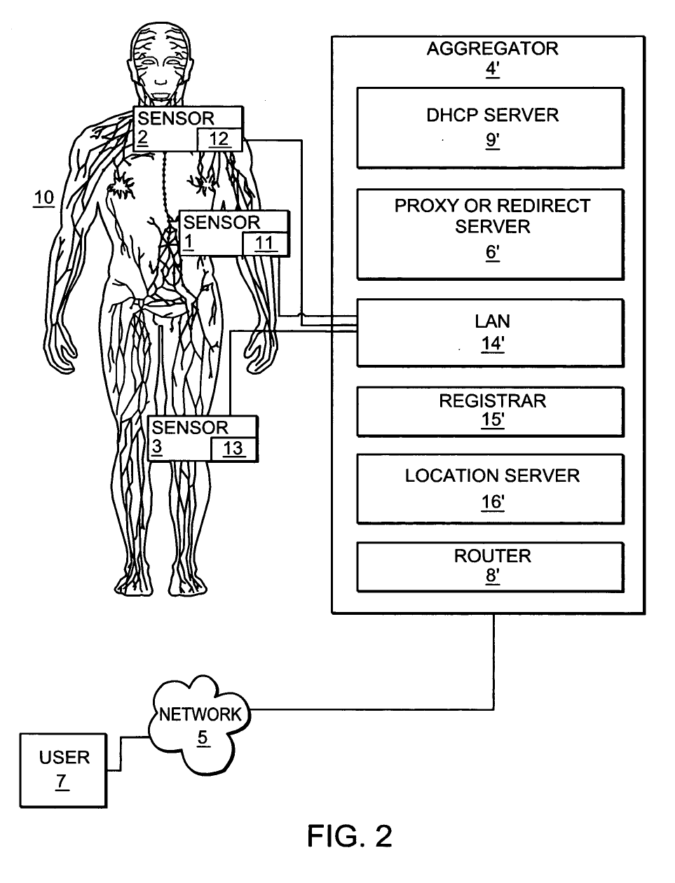

The embodiment shown in FIG. 2 combines the functionality of the DHCP server 9′, the SIP proxy or redirect server 6′, the SIP registrar 15′, the SIP location server 16′, the LAN 14′ and the IP router 8′ into a single device, an aggregator 4′. These components are implemented as software and/or hardware modules functioning within the single device. In this embodiment, the exchange of information between these functional components occurs within the aggregator 4′.

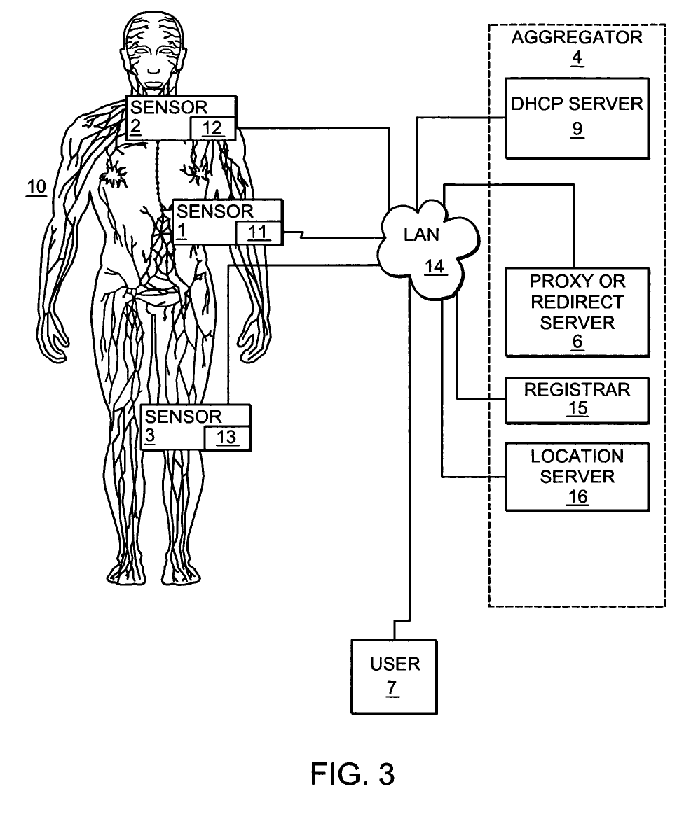

In the embodiment shown in FIG. 3, the user 7 is connected to the same local network 14 as the DHCP server 9, the SIP proxy or redirect server 6, the SIP registrar 15, and the SIP location server 16. In this embodiment, the communications between the user 7 and the other components occur as described for the embodiment shown in FIG. 1 but without the IP router 8 and using only a local network 14.

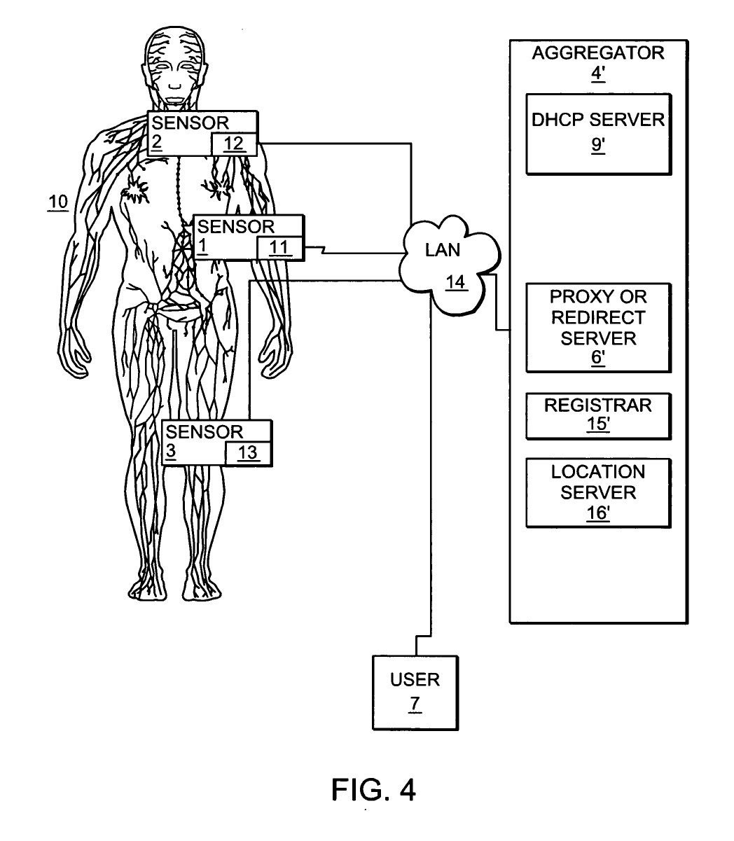

The embodiment shown in FIG. 4 combines the functionality of the DHCP server 9′, the SIP proxy or redirect server 6′, the SIP registrar 15′, and the SIP location server 16′ into a single device, an aggregator 4′. These components are implemented as software and/or hardware modules functioning within the single device. In this embodiment, the exchange of information between these functional component occurs within the aggregator 4′ and outside the local network 14. The user 7, the aggregator 4′, and the sensors 1-3 are connected to the same local network 14. In this embodiment, the communications between the user 7 and the other components occur as described for the embodiment shown in FIG. 1 but without the IP router 8 and using only a local network 14.

In other embodiments of this invention, the sensors 1-3 may transmit the data not only after exchanging SIP messages with SIP UAs, as described above, but also by including the data into the transmitted SIP messages. For example, in some embodiments, sensors 1-3 periodically send SIP INVITE messages to the user 7 and embed the sensor data within these messages. In other embodiments, the data are embedded into SIP REGISTER messages, and the user 7 obtains these data from the server 6 or aggregator 4 or 4′.

In other embodiments the SIP messages carrying the data may be transmitted anonymously, thus allowing the user 7 to collect data without knowing the identity of the source or patient. Such embodiments may be useful, for example, to protect anonymity and during clinical trials of medications. Note that such embodiments require less information during the initial sensor setup performed after a sensor is turned on.

While this invention has been particularly shown and described with references to preferred embodiments thereof, it will be understood by those skilled in the art that various changes in form and details may be made therein without departing from the scope of the invention encompassed by the appended claims.

1. A method for network communication of sensor devices on a network comprising the steps of:
connecting a sensor device to a first network;
connecting an aggregating device to the first network; and
transmitting sensor information from the sensor device to the aggregating device.

2. The method of claim 1 wherein the sensor information is transmitted using the Session Initiation Protocol (SIP).

3. The method of claim 2 wherein the sensor device is an SIP user agent.

4. The method of claim 2 wherein the aggregating device is an SIP server.

5. The method of claim 1 wherein the sensor device is a physiology sensor device.

6. The method of claim 1 further comprising:
connecting a second sensor device to the first network; and
transmitting sensor information from the second sensor device to the aggregating device.

7. The method of claim 6 wherein the sensor devices are heterogeneous.

8. The method of claim 1 further comprising connecting the aggregating device to a second network.

9. A method for network communication of sensor devices on a network comprising the steps of:
connecting a sensor device to an aggregating device;
connecting the aggregating device to the network; and
transmitting sensor information from the sensor device to the aggregating device.

10. The method of claim 9 wherein the sensor information is transmitted using the Session Initiation Protocol (SIP).

11. The method of claim 10 wherein the sensor device is an SIP user agent.

12. The method of claim 10 wherein the aggregating device is an SIP server.

13. The method of claim 9 wherein the sensor device is a physiology sensor device.

14. The method of claim 9 further comprising:
connecting a second sensor device to the network; and
transmitting sensor information from the second sensor device to the aggregating device.

15. The method of claim 14 wherein the sensor devices are heterogeneous.

16. A system for network communication of sensor devices on a network comprising:
an aggregating device connected to the network; and
means for connecting one or more sensor devices to the network such that respective sensor information is transmitted from each sensor device to the aggregating device.

17. The system of claim 16 wherein the sensor information is transmitted using the Session Initiation Protocol (SIP).

18. The system of claim 17 wherein each sensor device is a SIP user agents and the aggregating device is an SIP server.

19. The system of claim 16 wherein at least one of the sensor devices is a physiology sensor device.
